(19) United States
(12) Patent Application Publication
(10) Pub. No.: US 2014/0228035 A1
(43) Pub. Date: Aug. 14, 2014

(54) MULTIPOINT-TO-MULTIPOINT BASE STATION COMMUNICATION

(71) Applicant: MARIANA GOLDHAMER, RAMAT GAN (IL)

(72) Inventor: MARIANA GOLDHAMER, RAMAT GAN (IL)

(21) Appl. No.: 14/174,302

(22) Filed: Feb. 6, 2014

(30) Foreign Application Priority Data
Feb. 10, 2013 (IL) 224640

(51) Int. Cl. H04W 84/04; H04W 72/04

(52) U.S. Cl. CPC H04W 84/042; H04W 72/04
USPC 455/446; 455/450; 455/454; 455/561

(57) ABSTRACT

A communication system includes at least first, second and third base stations (711, 722, 733, 744), which are configured to communicate over the air with mobile user equipment (203, 204) in a cellular communications network. Embedded user equipment (UE11, UE12, . . . , UE45, UE46) is collocated with the base stations and configured to communicate over the air via the cellular communications network so as to convey communication messages between the base stations. The embedded user equipment includes at least first and second user equipment, which are embedded in the first base station and are configured to communicate with the second and third base stations respectively; third and fourth user equipment, which are embedded in the second base station and are configured to communicate with the first and third base stations respectively; and fifth and sixth user equipment, which are embedded in the third base station and are configured to communicate with the first and second base stations respectively.

### CROSS-REFERENCE TO RELATED APPLICATIONS

This application claims priority from Israeli patent application No. 224,640 titled “MULTIPOINT TO MULTIPOINT BASE STATION COMMUNICATION” filed on Feb. 10, 2013 which is incorporated herein by reference in its entirety.

### FIELD OF THE INVENTION

The present invention relates generally to digital communication and more specifically to cellular communications.

### 1. BACKGROUND

The existing cellular technology includes the point-to-multipoint base-station to/from relay communication, in which a donor base station (DeNB in LTE) communicates with a relay base station, named in LTE Relay Node (RN).

The Relay Node was defined in 3GPP standard TS 36.216 V11.0.0 (2012-09), “3GPP; Technical Specification Group Radio Access Networks; Evolved Universal Terrestrial Radio Access (E-UTRA), Physical layer for relaying operation (Release 11).

In the existing cellular implementations, for both FDD and TDD, the system architecture is based on the Point-to-Multipoint (P-MP) architecture described in FIG. 1.

A donor eNB (base station) 101 provides full-duplex connection to wireless UEs-102 (User Equipment) and to a number of partial UEs (113, 123), each of them being collocated with a secondary eNB (112, 122), these eNBs named relays further serving the wireless UEs 114, 124. The scope of the full-duplex connection is to transmit user data from the donor eNB to the Relay node and also in the reverse direction.

This approach is also used in the US patent applications US2009/0252203 A1 and US 2012/0106502 A1.

The work leading to this invention has received 20% funding from the European Union Seventh Framework Programme (FP7/2007-2013) under grant agreement n° 318784.

### 2 BRIEF SUMMARY

An embodiment of the present invention provides a communication system, comprising at least first, second and third base stations, which are configured to communicate over the air with mobile user equipment in a cellular communications network and embedded user equipment, collocated with the base stations and configured to communicate over the air via the cellular communications network so as to convey communication messages between the base stations, the embedded user equipment comprising at least first and second user equipment, which are embedded in the first base station and are configured to communicate with the second and third base stations respectively; third and fourth user equipment, which are embedded in the second base station and are configured to communicate with the first and third base stations respectively; and fifth and sixth user equipment, which are embedded in the third base station and are configured to communicate with the first and second base stations respectively.

There is also provided a method for communication among at least first, second and third base stations, which are configured to communicate over the air with mobile user equipment in a cellular communications network, the method comprising embedding user equipment in each of the base stations, comprising at least first and second user equipment embedded in the first base station, third and fourth user equipment embedded in the second base station, and fifth and sixth user equipment embedded in the third base station; operating the first and second user equipment to communicate over the air via the cellular communications network with the second and third base stations respectively; operating the third and fourth user equipment to communicate over the air via the cellular communications network with the first and third base stations respectively and operating the fifth and sixth user equipment to communicate over the air via the cellular communications network with the first and second base stations respectively.

There is also provided a cellular base station, comprising signal processing and control circuitry, configured to communicate over the air with mobile user equipment in a cellular communications network and embedded user equipment, collocated with the signal processing and control circuitry and configured to communicate over the air via the cellular communications network, the embedded user equipment comprising at least: first and second user equipment, which are configured to convey communication messages concurrently between the cellular base station and at least first and second other base stations, respectively, in the cellular communications network.

Other embodiments are presented in the detailed description, accompanying figures and claims.

### 3 BRIEF DESCRIPTION OF THE DRAWINGS

For a better understanding of embodiments of the invention and to show how the different embodiments may be carried into effect, reference will now be made, purely by way of example, to the accompanying drawings in which like numerals designate corresponding elements.

In the accompanying drawings:

FIG. 1—Represents the connectivity using the existing relay concept.

FIG. 2—Represents an example of up-link unidirectional transmissions which create full-duplex connectivity in our MP-MP system.

FIG. 3—Represents the bi-directional transmissions for controlling the Uu air interface.

FIG. 4—Represents an example of the LTE uplink physical channel allocation.

FIG. 5—Represents an example of the resource allocation using only the uplink channel for unidirectional transmission and reception.

FIG. 6—Represents an example of using only the downlink channel for unidirectional transmissions.

FIG. 7—Represents an inter-base station MP-MP communication system using only the uplink channel.

FIG. 8—Represents an example of time-frequency resource allocation for a first base station operating according to the example in FIG. 7.

FIG. 9—Represents an example of avoiding the saturation of the collocated UE.

FIG. 10—Represents an example of allocating time-frequency resources in case of synchronized eNBs such to maximize the available free spectrum.

FIG. 11—Represents combined inter-base station communications over the air and over the backhaul.

FIG. 12—Represents a base station architecture with embedded UEs.

FIG. 13—Represents another base station architecture with embedded UEs.

### 4 DETAILED DESCRIPTION

One of the targets of this invention is to provide a solution for inter-base station connectivity considering the traffic asymmetry affecting the availability of time-frequency resources. The general communication pattern is downlink-centric, with DL(downlink):UL(uplink) traffic ratios of 4:1 up to 9:1. In such conditions, the inter-base station communications should not use the precious downlink resources and introduce user throughput limitations, as is the case in the relay solutions described in 3GPP TS 36.216 V11.0.0 (2012-09).

A reverse asymmetry factor may occur when some video surveillance applications use extensively the uplink channel, while the downlink channel remains mostly unused for the user traffic. Because the RN transmits to the donor base station using the time-frequency resources in the uplink channel, the video throughput of the uplink channel is reduced.

The resulting new architecture enables a real cellular mesh or MP-MP system with minimum constraints.

An embodiment of the present invention provides a method for direct base station (eNB) communication designed to provide maximum backward compatibility with the UEs compatible with LTE Re1.8, but its general applicability is not limited to such system, being suitable to all the FDD or TDD wireless systems using technologies such as HSDPA (CDMA), WiMAX (IEEE 802.16), etc.

The embodiments disclosed herein use FDD (Frequency Division Duplex) allocations. However given that TDD (Time Division Duplex) systems, due to inter-cell interference mitigation considerations, use a fixed downlink/uplink split, the resources used for direct base station to base station communication may be used in each of the downlink or uplink partitions.

While the existing art is considering an architecture in which the donor base station transmits and receives information to a UE collocated to a base station, no communication being possible between these base stations, in this invention there is a flat architecture in which the data transmissions are unidirectional, being possible three modes:

Mode 1:

Unidirectional transmissions from the collocated UE to the other base station. Such transmissions take place within the frequency resources reserved for up-link operation, i.e. the uplink FDD channel in FDD allocations or in the up-link subframes in TDD allocations.

Mode 2:

Unidirectional transmissions from the base station to the collocated UE. Such transmissions take place within the frequency resources reserved for downlink operation, i.e. the downlink FDD channel in FDD allocations or in the downlink subframes in TDD allocations.

Mode 3:

Bidirectional transmissions between an eNB and the UE co-located with another eNB.

In the following description it is used a terminology familiar to those skilled in wireless networks and in particular in LTE technologies. This should not be considered as a limitation for the general applicability of the invention to other scheduled wireless or wired systems, like HSDPA or other systems using the CDMA or OFDM/OFDMA technology over the air or over wires, including xDSL and power-line networks.

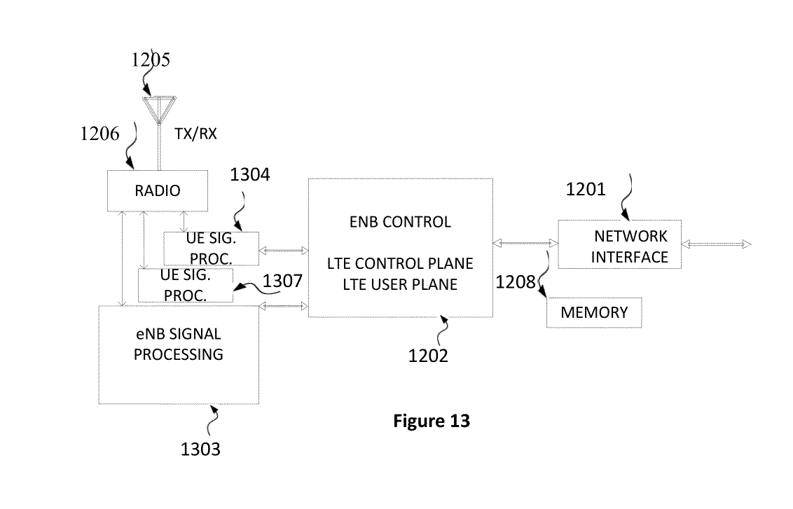

The term “User Equipment” (UE) indicates a device capable of communicating with a base station over the air. The UE (or partial UE) can be also collocated with a base station for communicating with the peer base station; inter-base station communication in embodiments of this invention uses some low-level features of the regular UE functionality, such as the UE physical and control layers. Collocation may imply that the UE (or partial UE) is embedded within the base station. As result, a base station configured for communication over the air will comprise at least two radio entities, one behaving like a base station and the other one(s) behaving like an UE. These radio entities, however, may share certain physical resources, as shown, for example, in FIGS. 12 and 13.

As well known to those skilled in the art, the LTE FDD DL (downlink) and UL (uplink) frames are composed of ten subframes, on which are mapped the LTE physical channels.

An UE collocated with an eNB will associate with the pair eNB while following the standard procedures described in 3GPP TS 36.300 V11.3.0 (2012-09), including the power control and Time Advance setting. These procedures are also used in a system operating according to an embodiment of the present invention.

The physical layer of the LTE UE and base station is described in 3GPP TS 36.211 V11.1.0 (2012-12), while the UE control procedures are described in 3GPP TS 36.331 V11.1.0 (2012-09). All these standards are updated quarterly.

Embodiments of the invention are described hereinafter in conjunction with the figures.

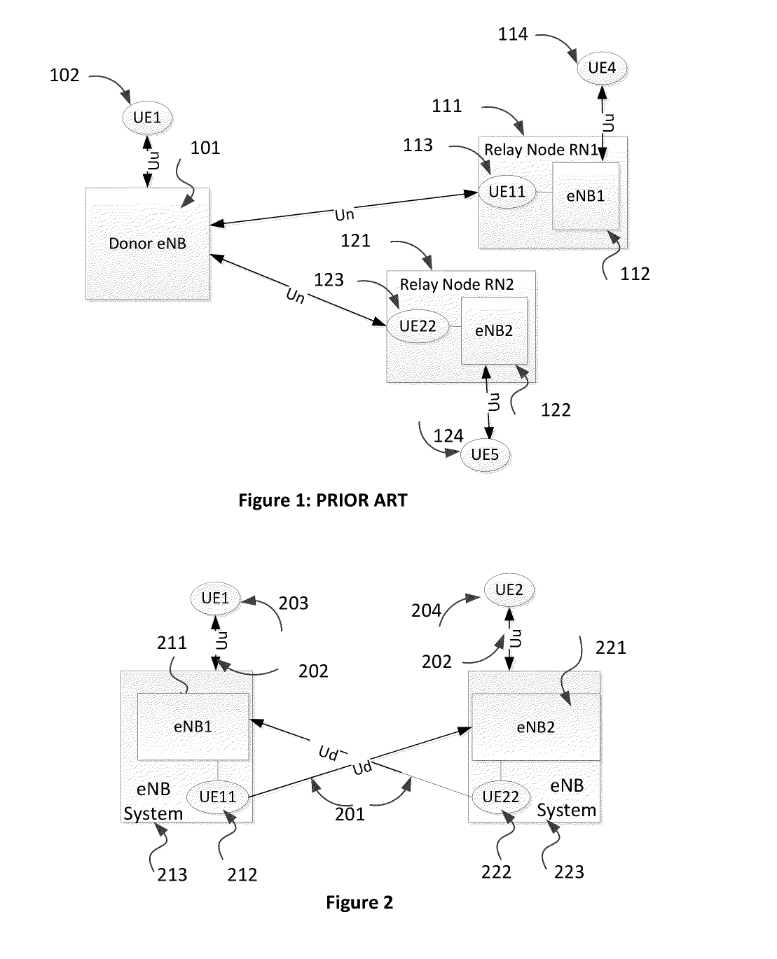

In FIG. 1 are shown the existing relay connections in networks that are known in the art: the donor eNB (DeNB)-101 communicates in a bi-directional mode with its regular UEs, such as UE1-102, over the Uu air interface. The same donor eNB-101 communicates with the RN1-111 and/or RN2-121. Each RN (111 or 121) includes an UE and an eNB. For example, RN1-111 includes the UE11-113 and the eNB1-112. The DeNB 101 communicates in a bi-directional mode with RN1 through the UE11 and the same DeNB 101 communicates also in a bi-directional mode with RN2-121 through UE22-123, using in both cases the Un interface. The UE11-113 and the UE22-123 may be a separate entity or may be embedded, but they have to implement a subset of the UE functionality, including the physical layer, layer-2, RRC (Radio Resource Control) in order to wirelessly connect to the donor eNB. It should be observed that such UEs are not included on the DeNB side. In turn, each one of the DeNB, eNB11 and eNB22 communicate over the Uu air interface respectively with the regular UEs 102, 114 and 124.

FIG. 2 represents the communication system in a simplified embodiment of the present invention during the DATA transfer phase. The data includes user data and/or the high layer signaling, for example the X2 and/or S1 LTE interfaces. In this figure there are two communicating base station systems, the eNB1 system and the eNB2 system. Each eNB system 213 or 223 is composed of an eNB and a partial UE, i.e. eNB system 213 is composed of the eNB 211 and the partial UE 212. Each eNB can connect over the Uu interface—202 to regular UEs, as 203 and 204.

The data transfer between the two eNB Systems takes place through the transmissions of the partial UEs over the interface Ud-201, one of the targets of this embodiment. UE11-212 transmits to eNB2-221 and UE22-222 transmits to eNB1-211. The data transmissions over the interface Ud are UNIDIRECTIONAL regular uplink UE transmissions, using the corresponding parts of the UL physical layer, layer 2 and RRC control.

The system operation is fully symmetrical, being no special hierarchy, such that the term “DeNB” is not used.

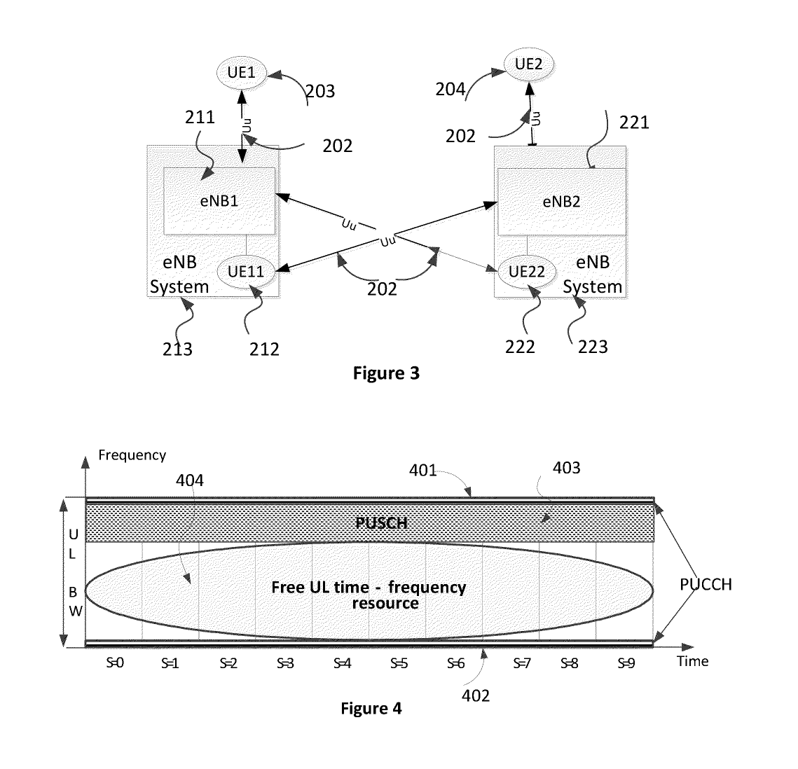

FIG. 3 represents the communication system in another simplified embodiment of the invention during the attachment phase and during the wireless link control operation. The only difference from the system in FIG. 2 is that the communication between the eNB 1-211 and the attached UE22-222 takes place over the regular Uu-202 interface. Same applies to eNB2-221 and the attached UE11-212. Similarly with the existing art, the low layer air interface control messages are bi-directional.

### Mode 1: Communication Using Only Uplink Frequency Resources

The up-link frequency resources are considered those frequency or time-frequency resources allocated for the data transmission executed by the wireless UEs. In FDD such resource is the uplink frequency channel, while in TDD it is the time interval reserved for uplink UE transmissions.

For taking advantage of the down-link centric traffic asymmetry, the inter-eNB transmissions through the partial UE should use the free time-frequency resources within the UL subframes not used by the collocated eNB.

PUCCH (Physical Uplink Control Channel) is mapped on the equivalent PRBs (Physical Resource Blocks, 180 kHz/PRB) at the channel edge and the uplink data is transmitted within the PUSCH (Physical Uplink Shared Channel), which may also include control information. An allocation for UE transmission spans over at least one subframe and includes in frequency domain an integer number of PRBs.

FIG. 4 shows the usage of an uplink FDD allocation by an LTE system. The PUCCH (401 and 402) is mapped on the PRBs at the channel edge. Its transmission comprises the ACK(Acknowledge)/NACK, scheduling request, periodic CQI (Channel Quality Indicator) feedback and other information sent within CSI (Channel State Information) reports.

In unsynchronized systems, where the Inter-Cell Interference Coordination (ICIC) takes place in frequency domain, the allocation 403 of the PUSCH may expand across the frequency domain. An allocation for UE transmission includes an integer number of PRBs (Physical Resource Blocks); the number of PRBs will depend on the actual traffic, but for simplification we consider that the same number of PRBs is reserved for PUSCH in all the subframes.

In one embodiment, the PUSCH near one of the PUCCH allocations may be reserved for making continuous room for the other usages of the free time-frequency resource—404.

For example, if we consider a 10 MHz frequency channel composed of 50 PRBs, the extreme two PRBs on each side will be reserved for PUCCH, while ⅓ of the remaining ones, i.e. 15 PRBs will be reserved for PUSCH. The remaining 31 PRBs are in fact a “free time-frequency resource”.

A good scheduling practice which may lead to a different PUSCH allocation is using the PUSCH resources located towards the center of the band, where the high power UE transmissions should be scheduled for reducing the OOB (out of band) emissions into the adjacent channels. With such approach the free time-frequency resources will be positioned between the central occupied PRBs and the PUCCH allocation.

Of course the allocation of the used resources could be more flexible, for example by using non-contiguous subframes or by using partial channel occupancy in contiguous or non-contiguous subframes.

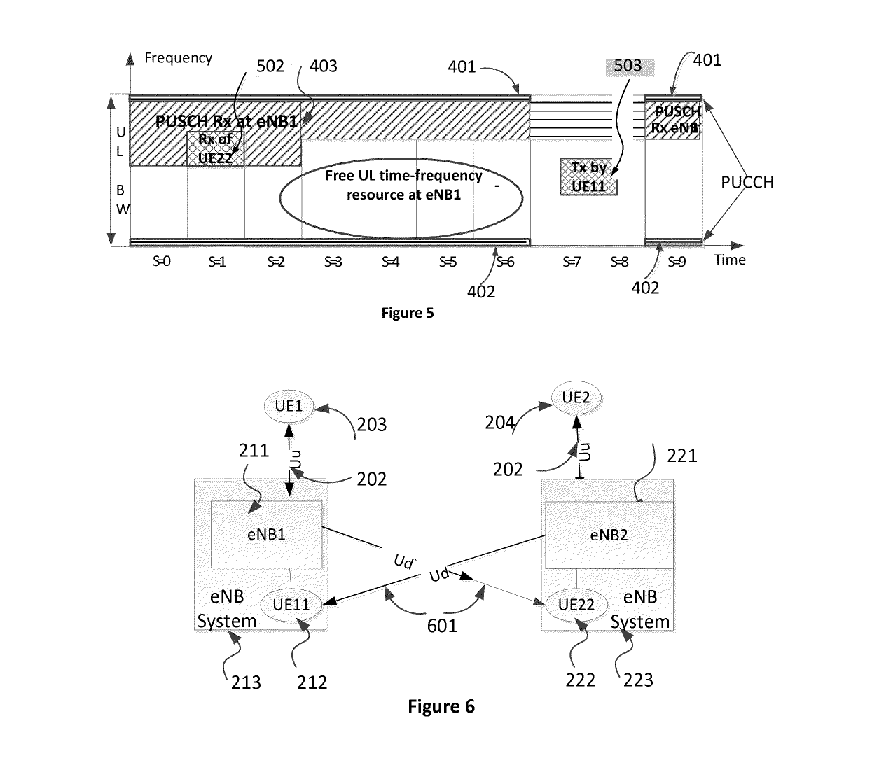

FIG. 5 provides an example of using the uplink time-frequency resources at the eNB1-211 location (see FIG. 2) in an embodiment of this invention. In this example there is no assumption of any stringent synchronization between eNB1-211 and eNB2-221, such that the UE11-212 transmission 503 to the serving eNB2-221 is not time-aligned with the eNB1 subframes. UE22 is served by eNB1 and its transmission is received by eNB1-211 in a time-aligned mode, for example within the time-frequency resource 502.

eNB1-211 acts as receiver for the regular transmissions over the Uu interface, including the PUCCH and the PUSCH. In this example the data transmissions from the partial UE22 in FIG. 2 are received as part of the PUSCH during the subframe S1.

Even if in FIG. 5 it is supposed that eNB1 and eNB2 are not synchronized, the transmissions of the partial UE22, collocated with eNB2-221, will be synchronized and time-aligned with the receiving eNB1, but they will not be time-aligned with the subframe start of eNB2. In the same way, the transmissions of the partial UE11, collocated with eNB 1, will be time-aligned with eNB2 but their alignment with the subframes of eNB 1 may be imprecise, because it may be based on the synchronization information transmitted by UE11 to eNB1 or on other mechanisms.

This case is a worst case, as a very good synchronization can be achieved over fiber or using satellites such as GPS or over the air.

During the transmissions of the partial UE11-212, collocated with the receiving eNB1-211, it is desirable to address the interference created by the UE11 transmitter to the reception of the of the regular up-link traffic by eNB 1. For doing this, eNB 1 should be aware of the resource allocation by eNB2 to UE11 or eNB2 should be aware of the resources not used by eNB1. This implies that messages should be exchanged between eNB 1 and eNB2 for the coordination of resource usage, eventually over the X2 interface.

### Mitigation of the Interference Created by the Collocated UE Transmitter

If both eNB1 and UE11 use directional antennas, a 60-70 dB interference reduction can be obtained. This may be sufficient for mitigating the interference caused by UE 11 if the up-link scheduling is such that the received signals at eNB1 come from UEs in the vicinity and can have high power.

In the general case it is desirable to use a scheduling method in order to avoid any receive activity on PUSCH and on PUCCH during the partial UE transmissions. While the scheduling of the PUSCH and the independent UE transmissions in different subframes are easy to accomplish, the activity on the PUCCH may be, based on the current LTE specifications, a response to the downlink activity towards a specific UE.

For example, this is the case for the FDD ARQ process, being a fixed 4 frames offset between the DL transmission and the UE feedback on the uplink. In TDD there is also a fixed delay depending on frame configurations.

The possible solutions to this problem are:

A. Use of the corresponding DL subframe (four frames in advance) for broadcast transmissions or for ABS (Almost Blank Subframes), which do not involve retransmissions and an HARQ (Hybrid Automatic Repeat Request) process;

B. Use of delayed HARQ responses, as is the case in TDD, also for FDD. In TDD the delayed and sometimes concatenated HARQ feedback takes place due to the fact that 4 frames after the UL transmission may be scheduled a downlink subframe, such that the feedback is not possible and has to be postponed.

### Mode 2: Communication Using Only Downlink Frequency Resources

The downlink frequency resources are considered those frequency or time-frequency resources allocated for the base station transmissions. In FDD such a resource is the downlink frequency channel, while in TDD it is the time interval reserved for downlink eNB transmissions.

This mode of operation should be used in cases in which there are more free frequency resources in the downlink frame as compared with the uplink frame.

We still use the setup in FIG. 2, with the eNB to the partial UE communication directions as shown for the Ud interface—601 in FIG. 6.

Based on the architecture in FIG. 6, the partial UE22 will receive data traffic from eNB1 while using the regular downlink transmission procedures. In order to avoid interference to the partial UE22 created by the collocated eNB2, the eNB2 should insert blank subframes during the reception at UE22 on the all downlink transmissions using the same radio band as UE22.

By blank subframes we mean, depending on the resulting interference, the following types of subframes: the transmission of PRBs with no data, control and reference signals, MBSFN (Multimedia Broadcast Single Frequency Network) subframes with no data, control and reference signals, ABS (Almost Blank Subframes) without data, subframes with absolutely no transmissions, etc.

The HARQ feedback to the downlink transmissions will be transmitted by the associated partial UE on the uplink frequency channel four subframes later; it is recommended to schedule the downlink transmissions so to not create too high power imbalances at the eNB receiver and also to take into consideration the interference created by the transmitting partial UE to the collocated eNB.

It should be noted that in this case the collocated UE is just a receiver so that is not creating interference.

### Mode 3: Bidirectional Transmissions

In this mode the collocated UE receives information from the serving eNB (as in Mode 2) and transmits information to the same serving eNB (As in Mode 1).

### Signaling by the Transmitting Entity

Another aspect of this invention is using the physical channels of the transmitting entity for mapping specific information to new physical channels. In Mode A, the transmitting entity is the partial UE collocated with the eNB, while in Mode B the transmitting entity is the eNB itself. By such a method a fast signaling mechanism can be established between eNBs. The content of such signaling could also be transmitted as messages between the communicating eNBs.

Such specific information may be the use of the PRBs in different subframes by the collocated eNB or requests to use one or more specific PRBs or acknowledge the use of such resources.

### Avoiding Collocated UE Radio Saturation by Configuring Blank Subframes

The UE radio receiver could be saturated by DL transmissions of the collocated eNB using the same frequency band. Due to this saturation the collocated UE may not receive the synchronization and control channels sent by the serving eNB.

A solution to this problem may be provided by blanking those collocated eNB subframes causing interference to the synchronization and control channels used by the collocated UE. For example, if the collocated UE uses a PSS (Primary synchronization signal) in subframe 0 and its traffic is scheduled in frames 0 and 2, the collocated eNB should shift its subframe zero by one subframe and configure the blanking of its subframes 9 and 1, as shown in FIG. 9. In this figure the serving eNB uses the sequence of subframes 901, while the collocated eNB uses the sequence of subframes 902. The subframes S1 and S9, corresponding to subframes S0 and S2 on the serving eNB, are blanked. The secondary synchronization signals may not be needed, especially when the base stations do not move.

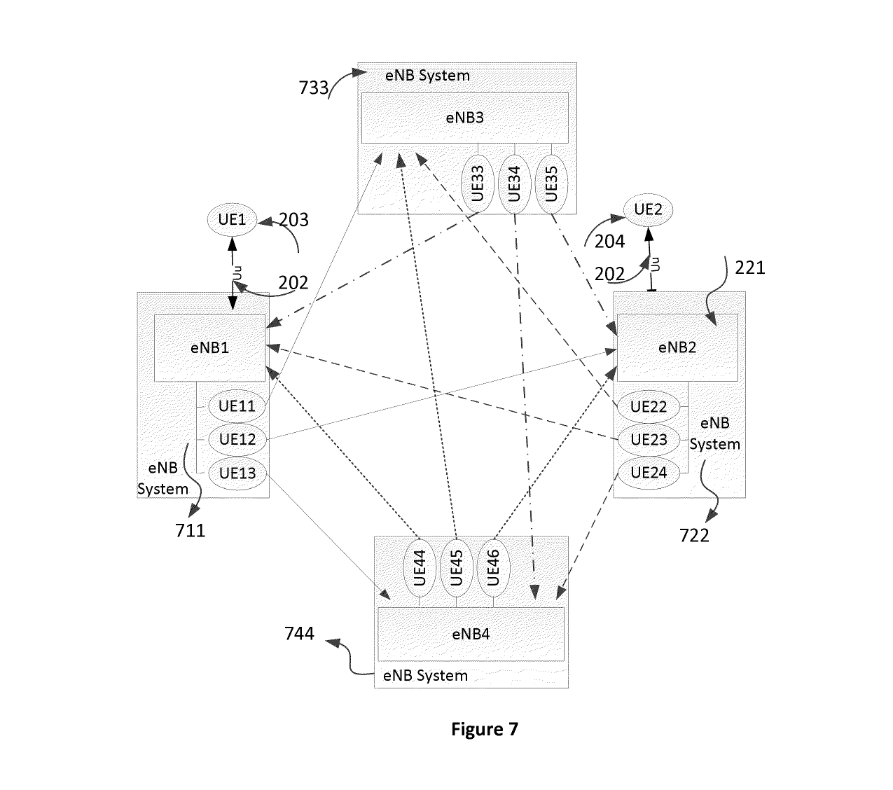

In case of multiple collocated UEs (see FIG. 7) carrier aggregation can be used, such that each UE will use a Pcell (Primary cell) on a different component carrier, which for the UEs served by the collocated eNB will be used as a Scell (Secondary carrier) on which only those subframes not creating interference to the collocated UE are used. Note that no control or synchronization channels are expected by an UE on a Scell, so that blanking some subframes does not create problems.

### Avoiding Collocated UE Radio Saturation by Using Messages

A second possibility for avoiding saturation is to replace the physical synchronization and control channels with messaging over the backhaul or over another unidirectional link, as described below.

Referring to FIG. 2, the operation of the partial UE11-212 and UE22-222 include an attachment or association phase and a wireless link operation phase in which user data and air interface control messages are exchanged bi-directionally, the most important being the resource allocation for DL and UL transmission. The Control Channels include the HARQ mechanism which indicates the correct reception, the request for allocation of resources for the UL transmission, power control, and transmit time adjustments.

In LTE FDD the HARQ mechanism is synchronous and involves a four subframe shift between the data transmission and the ACK/NACK feedback. The ACK/NACK feedback uses the PHICH (Physical Hybrid ARQ Indicator Channel) for the data transmitted in uplink.

For example, in the case of UE22-222 in FIG. 2, information related to seeking resource allocation for UL (Buffer Status Report, Scheduling Request) and Data Transfer use the UL time-frequency resources, while DL information such as Allocation of Resources, Power control, MCS (Modulation and Coding Scheme), HARQ (Hybrid Automatic Repeat Request) ACK/NACK (Acknowledgement/Negative ACK), Time Advance, Sounding scheduling use the downlink resources which may be interfered by the collocated eNB.

The information mapped to and carried by the DL control channels or Shared Channels can be transformed into messages which are conveyed to the eNB collocated to the target UE. This eNB conveys the messages to the UE. However the delay in conveying delay-sensitive messages can be too high, leading to disruption in operation. However, a suitable change of the LTE standards can accommodate such an information transmission mode and the associated delays.

Avoiding Collocated UE Radio Saturation by Using Inter-Band CA

Another solution consists in using CA (carrier aggregation) between component carriers located in different frequency bands, such that the radio filters on the UE will prevent saturation.

For example, the collocated UE can be configured with a downlink primary cell (Pcell) in one frequency band, while the DL transmissions of the collocated eNB are configured to take place in another frequency band, such that no saturation will be created by these transmissions.

A possible embodiment of this method is to use a license-exempt (LE) band or a shared band for the inter-eNB communication, while the Pcell is configured in a licensed band. In this case the synchronization and the control channels will use the licensed bands. The use by the secondary cell of a shared or LE-band may involve the detection of primary band users (for example radars or TV transmitters). Regulations may also require the assessment of a free medium before transmissions based on energy detection (Listen Before Transmit).

When using a LE/shared band the regulations limit the power of the transmissions. Mode 1 presents the advantage of possible power concentration (within the limits of the radio regulations), such that it is possible to achieve a better coverage when using it.

The techniques presented above can be combined in a practical implementation, depending on the configuration of the equipment.

### Multiple eNB to eNB Connections Using Uplink Frequency-Time Resources

Based on the flat architecture presented in FIG. 2 and FIG. 5, an embodiment of the present invention can provide multiple eNB-eNB connections.

An architecture example using the uplink frequency resources is provided in FIG. 7. In this figure a dedicated partial UE is used for the connection to each other eNB. For example, eNB4-744 uses the collocated partial UE44 for communicating with eNB1-711, UE45 for communicating with eNB3-733 and UE46 for communicating with eNB2-722.

The multiplexing in time domain of one partial UE for connections with several eNBs is also possible, as long as the UE keeps the context of each eNB connection. In this mode, the UE will use different subframes for communication with different eNBs.

In LTE, given the SC-FDMA (Single Carrier Frequency Division Multiple Access) approach, one partial UE can transmit only on adjacent frequency resources in a subframe. The UE can use a single carrier or can implement Carrier Aggregation between different component carriers.

It is also technically feasible to use for communication with a different eNB multiple component carriers, as in Carrier Aggregation, with the observation that the HARQ process and other control processes will take place for each UE on the assigned Pcell. Based on the existing LTE standard, the control messages are transmitted only on the primary component carrier.

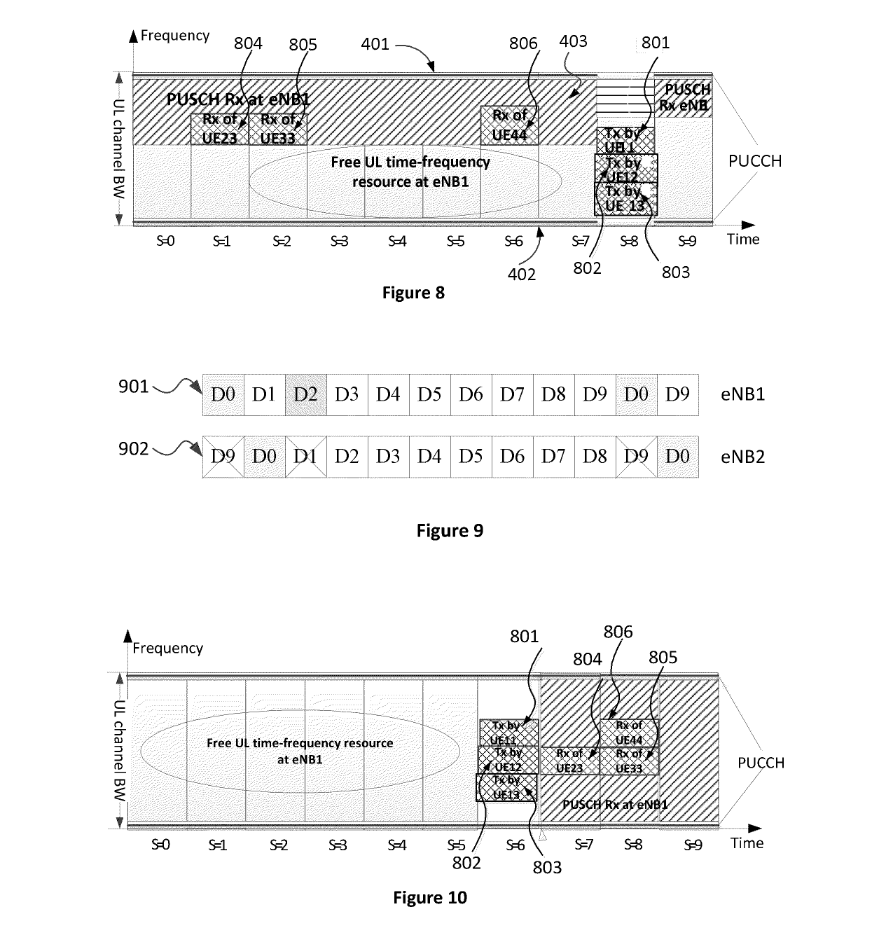

An embodiment providing MP-to-MP (multipoint) inter-eNB communications will now be described. This embodiment, based on the architecture in FIG. 7 and the resource allocation example in FIGS. 8 and 9, is optimized for the minimization of the number of used subframes and/or blank eNB subframes. The example in FIG. 8 assumes synchronization of the eNBs.

Another condition is that the transmission Time Advance does not create significant reception errors of the collocated receiving entity. This can be achieved either due to the relative short distance or by a suitable scheduling policy of the resources used and not used in the adjacent subframes to those used by the transmitting entity.

The minimization of the number of used subframes can be based on the LTE eNB aggregation of UE communication in an UL or DL subframe, exemplified for Mode 1, as follows:

A scheduling restriction occurs for the transmissions of the collocated partial UE towards different eNBs, because during such transmission the collocated eNB should avoid scheduling of any other receptions on the same frequency channel and overlapping subframes.

For limiting such operation to only one subframe, the communicating eNB should be synchronized at the subframe level. In case of not fully synchronized eNBs the transmissions may occupy two subframes, as shown in FIG. 5.

Each partial UE should carry an attribute indicating its special usage for inter-eNB communication. This attribute will indicate to the serving eNB the role of the UE and the fact that there may be scheduling restrictions to be coordinated with the collocated eNB of this UE through appropriate messages or signaling, indicating the resource availability in both eNBs and down-selecting the candidate time-frequency resources (subframe, start PRB, number of PRBs) to be used.

The collocated eNB should take measures for avoiding interference, for example to avoid regular reception during the subframes used for transmission. These measures may include scheduling of downlink traffic as has been explained previously.

As the partial UE may need to adjust its Time Advance based on the feedback from the serving eNB, it is desirable that the mitigation of the inter-subframe interference described above be used. If this is not possible, different UEs or different subframes can be used for each communication link in FIG. 7.

FIG. 8 shows scheduling of MP-MP communication between four eNBs using only one dedicated subframe at each eNB. Of course more subframes may be used if this is justified by the amount of data to be transferred. For scheduling multiple parallel transmissions to multiple eNBs, as shown in FIG. 7, based on the rule of avoidance of interference created by these transmissions, which translates to avoidance of scheduled receptions at the collocated eNB during the transmitting subframe, different eNBs should use different subframes for the transmissions by the collocated partial UE. An example of such an arrangement is shown in FIG. 8.

In FIG. 8 it can be observed that all the UEs collocated with eNB1, i.e. UE11, UE12 and UE13, use different PRBs for transmission during subframe 8, respectively the time-frequency resources 801, 802 and 803. No receptions by eNB1 are scheduled during this subframe. However, transmissions may be scheduled in these subframes by eNBs collocated with these UEs, such that a protocol is needed that includes messages for avoiding contentions between these transmissions. An additional burden is generated by the fact that the data amounts to be transmitted may vary in time. A solution to this problem may be the allocation of the resources for each collocated partial UE transmission by the collocated eNB, within the subframe(s) and frequency resources allocated for these transmissions. This approach makes sense as the collocated eNB is aware of the queue status of each collocated UE.

The collocated eNB may use messages for distributing information about the resources recommended for use by the collocated partial UE in transmission to the eNB serving the partial UE.

The receptions 804, 805, 806 by eNB1 of the respective transmissions from the UE23, collocated with eNB2, UE33, collocated with eNB3, and UE44, collocated with eNB4, do not have special requirements and can be included in the regular PUSCH of eNB 1. However, the general ICIC/eICIC interference coordination should be applied also to the scheduling of these receptions.

FIG. 10 shows another repartition of the PUSCH resources, also based on synchronization between eNBs. In this arrangement the PUSCH resources are grouped so as to occupy a minimum number of subframes and the underlying assumption is that the interference coordination between cells is done in the time domain (eICIC), while in the unsynchronized case it was done in the frequency domain based on the occupied PRBs.

### Multiple eNB to eNB Connections Using Downlink Frequency-Time Resources

As described above for communication Mode 2, the eNB will transmit to the partial UE collocated with the peer eNB while using the time-frequency resources allocated for downlink operation within the PDSCH (Physical Downlink Shared Channel). The eNB collocated with the receiving partial UE should insert blank subframes during the subframes used for reception by the partial UE or should use other interference mitigation methods, as described for Mode 2.

When applying the method of frequency isolation, another component carrier may be used or a guard-band can be created with one or more un-used PRBs.

### Communication Between Base Stations Using Different RATs

An interesting property of the architecture used in embodiments of the present invention is that base stations can use a RAT (Radio Access Technology) which is different from the technology used by the collocated UE while communicating with the other(s) base stations.

As in general the different radio technologies use different spectrum bands, if the transmission by the collocated UE uses a radio band not in use at the collocated base station, the interference caused by the transmissions of the collocated UE will be strongly mitigated by the band filters of both collocated UE and collocated base station.

Even if the same RAT is used by the communicating base stations, the usage of different spectrum bands will have the same interference mitigation effect.

### Data Relaying

The principles of the present invention can also be used for relaying data between a donor eNB and an UE, connected to the eNB communicating with the donor eNB.

### Unidirectional Data Communication

There are a number of cases in which data communication between base stations is needed only in one direction; for example, if xDSL (i.e. ADSL, etc.) is used as backhaul, the uplink capacity may be much lower than the downlink capacity.

For such cases it is sufficient to use a collocated UE which will convey only the data direction that may suffer from the transmitting media asymmetry.

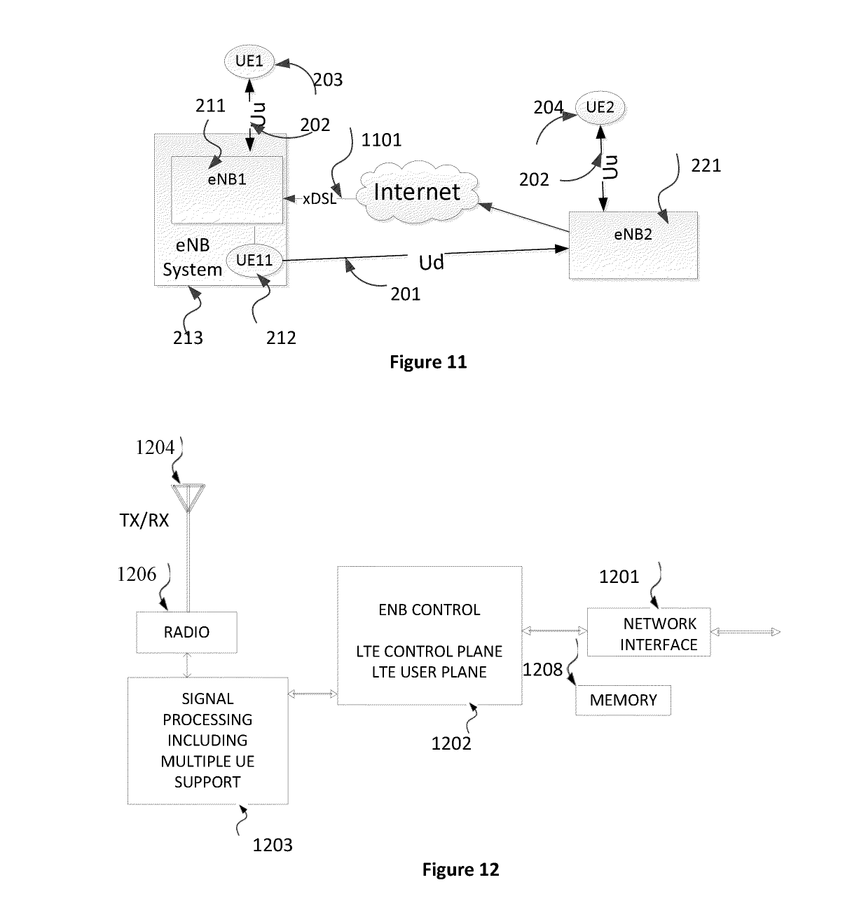

FIG. 11 exemplifies the use of the invention to overcome the xDSL uplink capacity limitations, when the eNB1 uses the xDSL backhaul—1101 and an eNB2 uses the cellular operator backhaul. In this figure the data sent by the Macro eNB arrives at the eNB1 over the xDSL, while the data sent by the small cell eNB is arrives at the eNB2 over the air.

Collocated eNB Internal Architecture

The modified eNB radio architecture is shown in FIG. 12 and FIG. 13. In these figures the base station modules include a Network Interface—1201, providing the data connection, and a Base Station Control Block 1202, including the LTE Control Plane and the LTE User Plane, which also transfers user data between the Network interface—1201 and a Signal Processing unit—different in FIG. 12 and FIG. 13, which in turn receives and transmits the baseband signals to the radios. The radio block 1206 connects to the signal processing units and its RF output connects to antennas 1205.

In FIG. 12 the Signal Processing unit 1203 includes multiple collocated UE support, while in FIG. 13 the eNB support is in block 1303 and the collocated UEs support is in block 1304 and 1307. Similar blocks can be added if more UEs are embedded or one block can support multiple embedded UEs.

A Memory block 1208, containing RAM and non-volatile memory (FLASH or ROM), is used by the eNB Control Unit 1202 and depending on the actual eNB implementation, may be used also by the Network Interface 1201.

What is claimed is:

1. A communication system, comprising:
at least first, second and third base stations, which are configured to communicate over the air with mobile user equipment in a cellular communications network; and
embedded user equipment, collocated with the base stations and configured to communicate over the air via the cellular communications network so as to convey communication messages between the base stations, the embedded user equipment comprising at least:
first and second user equipment, which are embedded in the first base station and are configured to communicate with the second and third base stations respectively;
third and fourth user equipment, which are embedded in the second base station and are configured to communicate with the first and third base stations respectively; and
fifth and sixth user equipment, which are embedded in the third base station and are configured to communicate with the first and second base stations respectively.

2. The system according to claim 1, wherein the base stations are configured to allocate only uplink time-frequency resources for data communication by the embedded user equipment with the serving base stations.

3. The system according to claim 1, wherein the base stations are configured to allocate only downlink time-frequency resources for data communication by the base stations with the embedded user equipment.

4. The system according to claim 1, wherein the base stations are configured to select time-frequency resources for data communication between the base stations and the embedded user equipment based on an assessment of available uplink and downlink time-frequency resources.

5. The system according to claim 1, wherein the base stations are configured to select time-frequency resources for data communication between the base stations and the embedded user equipment so as to avoid the simultaneous use of the same time-frequency resource by at least the first and second user equipment.

6. The system according to claim 1, wherein the base stations are configured to select time-frequency resources for data communication between the base stations and the embedded user equipment such that at least the first user equipment communicates with its serving base station in a frequency band which is different from the frequency band used by the collocated base station for communications with its served user equipments.

7. The system according to claim 1, wherein the base stations are configured to communicate over the air with the mobile user equipment using a first radio access technology, and to communicate with the embedded user equipment using a second radio access technology that is different from the first radio access technology.

8. The system according to claim 1, wherein the base stations are configured to communicate with the embedded user equipment using carrier aggregation.

9. The system according to claim 8, wherein the Pcell of the embedded user equipment is different from the Pcell of the mobile user equipment.

10. A method for communication among at least first, second and third base stations, which are configured to communicate over the air with mobile user equipment in a cellular communications network, the method comprising:
embedding user equipment in each of the base stations, comprising at least first and second user equipment embedded in the first base station, third and fourth user equipment embedded in the second base station, and fifth and sixth user equipment embedded in the third base station;
operating the first and second user equipment to communicate over the air via the cellular communications network with the second and third base stations respectively;
operating the third and fourth user equipment to communicate over the air via the cellular communications network with the first and third base stations respectively; and
operating the fifth and sixth user equipment to communicate over the air via the cellular communications network with the first and second base stations respectively.

11. The method according to claim 10, wherein operating the user equipment comprises allocating only uplink time-frequency resources for data communication by the embedded user equipment with the serving base stations.

12. The method according to claim 10, wherein operating the user equipment comprises allocating only downlink time-frequency resources for data communication by the base stations with the embedded user equipment.

13. The method according to claim 10, wherein operating the user equipment comprises selecting time-frequency resources for data communication between the base stations and the embedded user equipment based on an assessment of available uplink and downlink time-frequency resources.

14. The method according to claim 10, wherein operating the user equipment comprises selecting time-frequency resources for data communication between the base stations and the embedded user equipment so as to avoid the simultaneous use of the same time-frequency resource by at least the first and second user equipment.

15. The method according to claim 10, wherein operating the user equipment comprises selecting time-frequency resources for data communication between the base stations and the embedded user equipment such that at least the first user equipment communicates with its serving base station in a frequency band which is different from the frequency band used by the collocated base station for communications with its served user equipments.

16. The method according to claim 10, wherein the base stations are configured to communicate over the air with the mobile user equipment using a first radio access technology, and wherein operating the user equipment comprises communicating with the embedded user equipment using a second radio access technology that is different from the first radio access technology.

17. The method according to claim 10, wherein operating the user equipment comprises communicating with the embedded user equipment using carrier aggregation.

18. The method according to claim 17, wherein the Pcell of the embedded user equipment is different from the Pcell of the mobile user equipment.

19. The method according to claim 17, wherein the at least first user equipment uses at least one carrier in a shared or license-exempt band.

20. The method according to claim 10, where at least one subframe of the collocated base station is blanked for avoiding interference to at least the first embedded user equipment.

21. The method according to claim 10, where information is exchanged between base stations to indicate the time-frequency resource reservation for at least the first embedded user equipment.

22. The method according to claim 10, where information is exchanged between base stations to negotiate the amount of the reserved time-frequency resources for at least the transmission or reception by the first embedded user equipment.

23. A cellular base station, comprising:
signal processing and control circuitry, configured to communicate over the air with mobile user equipment in a cellular communications network; and
embedded user equipment, collocated with the signal processing and control circuitry and configured to communicate over the air via the cellular communications network, the embedded user equipment comprising at least: first and second user equipment, which are configured to convey communication messages concurrently between the cellular base station and at least first and second other base stations, respectively, in the cellular communications network.

24. The cellular base station according to claim 23, wherein the signal processing and control circuitry of the cellular base station is configured to perform at least a part of a functionality of the embedded user equipment in communicating over the air with the other base stations.

25. The cellular base station according to claim 23, wherein the embedded user equipment comprises signal processing support that is distinct from the signal processing and control circuitry of the cellular base station.
